(19) United States
(12) Patent Application Publication
(10) Pub. No.: US 2024/0106738 A1
(43) Pub. Date: Mar. 28, 2024

(54) Apparatuses, Devices, Methods and Computer-Readable Media for Communicating via Internet Doors

(71) Applicant: Intel Corporation, Santa Clara, CA (US)

(72) Inventors: Ilan HAMAMI, Tel Mond (IL); Ehud RESHEF, KIRYAT TIVON (IL); Ofer HAREUVENI, Haifa (IL); Menashe Shani BEN-HAIM, Tel Aviv (IL); Nevo IDAN, Zichron Ya'akov (IL)

(21) Appl. No.: 18/528,896

(22) Filed: Dec. 5, 2023

(51) Int. Cl. H04L 45/302; H04L 47/74

(52) U.S. Cl. CPC H04L 45/302; H04L 47/748

(57) ABSTRACT

Various examples relate to apparatuses, devices, methods and computer-readable media for handling connectivity packages. An apparatus for a gateway device comprises interface circuitry, machine-readable instructions, and processor circuitry to execute the machine-readable instructions to obtain information on a plurality of available connectivity packages, with each connectivity package defining a connection between the gateway device and an endpoint of an internet service provider, and with each connectivity package being characterized by one or more connection performance parameters, select one or more connectivity packages of the available connectivity packages for data traffic of a client device, and route the data traffic of the client device via one or more connections between the gateway device and a corresponding endpoint of the internet service provider associated with a respective connectivity package of the selected one or more connectivity packages.

### BACKGROUND

With all compute applications relying on connectivity and cloud services these days, the quality of user experience (QoE) for essentially all usages depends on the quality and availability of compute and connectivity resources along the end-to-end (e2e) path from the respective users' devices to the Internet sites providing services to users. The e2e path is generally divided into four major network segments—customer premises network (CP), access network (AN), transit networks (TN), and application providers networks and compute (ASP).

The term “user experience” (UX) includes all aspects that impact the expectations and feelings of a user while using the diverse services. It goes beyond application performance with respect to throughputs and latency, which are important aspects for the user experience, but do not provide a comprehensive picture.

The current trend is in bringing the cloud closer to the AN and CP. This is done by providing proximate compute power to the CP in the form of edge compute (EC, MEC). This trend brings ASPs closer to the CP, by collocating the EC at the AN and even at the CP, thereby shortening the e2e networking path. This trend makes the CP and AN segments the major network segments to focus on when improving the UX/QoE.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for a gateway device, and of a gateway device comprising such an apparatus or device;

FIG. 1b shows a flow chart of an example of a method for a gateway device;

FIG. 2a shows a schematic diagram of an example of an apparatus or device for a client device, and of a client device comprising such an apparatus or device;

FIG. 2b shows a flow chart of an example of a method for a client device;

FIG. 3a shows a schematic diagram of an example of an apparatus or device for a server, and of a server comprising such an apparatus or device;

FIG. 3b shows a flow chart of an example of a method for a server;

FIG. 4 shows a schematic illustration of a contemporary Internet access scheme;

FIG. 5 shows a schematic diagram of a network architecture that includes supports for multiple Internet access doors;

FIG. 6 shows different components and software being involved in some examples of the present disclosure;

FIG. 7 shows a schematic illustration of using multiple doors via multiple virtual pipes;

FIG. 8 shows a schematic diagram that illustrates an interaction between a gateway, client devices, and ISP doors;

FIG. 9 gives an overview of the network industry ecosystem; and

FIGS. 10a to 10c show flow charts for various processes described in the present disclosure.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

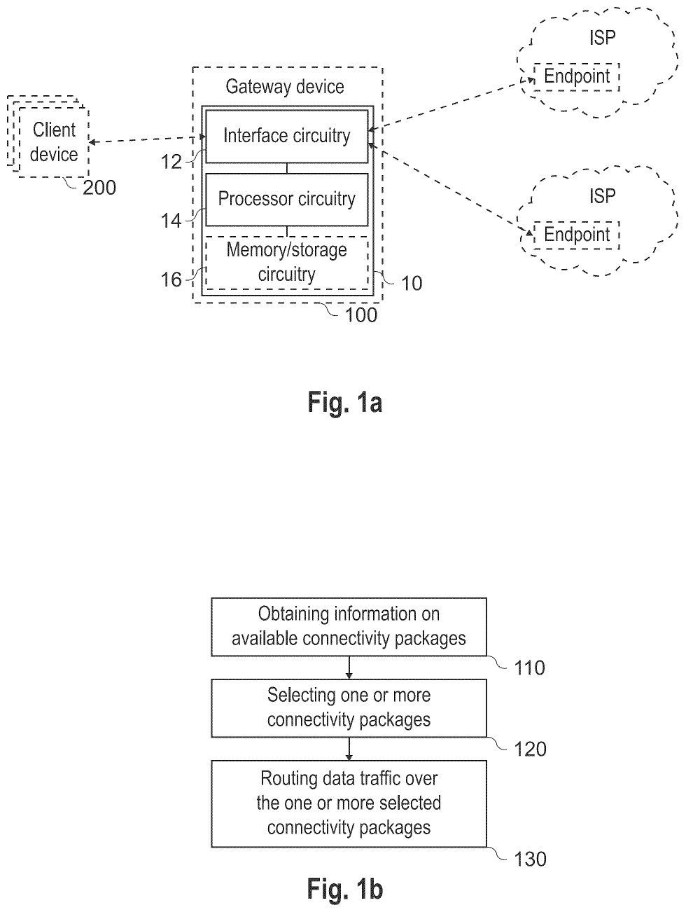

FIG. 1a shows a schematic diagram of an example of an apparatus 10 or device 10 for a gateway device, and of a gateway device 100 (e.g., a router or network gateway) comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processor circuitry 14, and (optional) memory/storage circuitry 16. For example, the processor circuitry 14 may be coupled with the interface circuitry 12 and/or with the memory/storage circuitry 16. For example, the processor circuitry 14 may provide the functionality of the apparatus, in conjunction with the interface circuitry 12 (for communicating with other entities inside or outside the gateway device 100), and the memory/storage circuitry 16 (for storing information, such as machine-readable instructions). Likewise, the device 10 may comprise means for providing the functionality of the device 10.

For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory or storage circuitry 16 or means for storing information 16.

The processor circuitry 14 or means for processing 14 is to obtain information on a plurality of available connectivity packages. Each connectivity package defines a connection between the gateway device and an endpoint of an internet service provider. Each connectivity package is characterized by one or more connection performance parameters. The processor circuitry 14 or means for processing 14 is to select one or more connectivity packages of the available connectivity packages for data traffic of a client device 200. The processor circuitry 14 or means for processing 14 is to route the data traffic of the client device via one or more connections between the gateway device and a corresponding endpoint of the internet service provider associated with a respective connectivity package of the selected one or more connectivity packages.

FIG. 1b shows a flow chart of an example of a corresponding method for a gateway device, such as the gateway device 100. The method comprises obtaining 110 the information on the plurality of available connectivity packages. The method comprises selecting 120 the one or more connectivity packages of the available connectivity packages for data traffic of a client device. The method comprises routing 130 the data traffic of the client device via the one or more connections between the gateway device and the corresponding endpoint of the internet service provider associated with a respective connectivity package of the selected one or more connectivity packages. For example, the method may be performed by the gateway device 100, e.g., by the apparatus 10 or device 10 of the gateway device 100.

In the following, the functionality of the apparatus 10, device 10, gateway device 100, and of the corresponding method and a corresponding computer program will be introduced in more detail with respect to the apparatus 10 and gateway device 100. Features introduced in connection with the apparatus 10 and gateway device 100 may likewise be included in the corresponding device 10, method and computer program.

FIGS. 1a and 1b relate to a gateway device, and to a processing component of the gateway device. In general, gateway devices, such as home or business routers, are network gateways that are used by one or more client devices 200 to access the internet, i.e., servers being accessible via the internet. In most cases, a gateway device is connected to one so-called Internet Service Provider (ISP) via an access network, with the Internet Service Provider providing the connection between the gateway device (e.g., via coaxial cable, fiber, a telephone line, a radio access network) and the internet. This connection has mostly fixed capabilities, such as a fixed maximal uplink/downlink throughput being provided by the ISP. In some cases, some gateway devices provide services like link aggregation or failover, which use connection to two different Internet Service Providers to improve the data throughput or reliability, but even in these cases, both connections have a fixed maximal uplink/downlink throughput.

In the present disclosure, this model of connecting to the internet is extended by the introduction of so-called connectivity packages. Connectivity packages, in the following also denoted “Internet Doors” are virtual pipes that can be booked by client devices connected to the gateway device. The internet doors (i.e., connectivity packages) are being offered and defined by the respective ISPs, rather than being defined by the client, with the client selecting one or more doors among the doors offered by the ISPs. They provide connections (between the gateway device and an endpoint of the ISP) that have certain properties, and in particular a certain Quality of Experience. While the QoE can include a promised minimal or maximal uplink/downlink throughput and latency, the concept of QoE goes far beyond numeric properties such as throughput and latency. It may include privacy aspects (e.g., an amount of data analysis for the purpose of providing advertisements), connectivity aspects (e.g., use of certain transit networks), availability of edge computing resources, availability of vertically integrated services, provision of services by a human or by a chatbot etc. Depending on the preferences of a user of the client device, and of the user's willingness to pay for a connection having the desired properties, virtual connections are created between the gateway device and the endpoint of the ISP according to these properties, and the traffic of the client device is routed over the appropriate virtual connections.

The connection(s) being established between the gateway device and the respective endpoint(s) of the ISP(s) depends on the availability of the so-called connectivity packages. As outlined above, each connectivity package a) defines a connection between the gateway device and an endpoint of an internet service provider and is b) characterized by one or more connection performance parameters. In particular, the different available connectivity packages provide different user experiences, as defined by the respective one or more connection performance parameters. For example, the plurality of different connectivity packages may differ with respect to one or more (e.g., at least two) performance characteristics of the group of data throughput (e.g., a minimal uplink and/or downlink throughput), priority level (e.g., whether data transmissions or use of a service is prioritized vis-a-vis other data transmissions or use of a service), latency (e.g., a maximal latency), transit network (e.g., which transit network(s) are used), edge compute location (e.g., how physically close an edge compute location being used to provide a service is), edge compute capacity (e.g., how much compute capacity is made available to the client device), privacy level (e.g., whether traffic routed via a connection associated with a connectivity package is used to profile the user of the client device), rating (e.g., a rating provided by users of other client devices, such as a privacy rating, a trust rating, and/or a performance rating), level of use of artificial intelligence by services provided as part of or via the connectivity package (e.g., whether a service being accessed via a connection associated with a connectivity package is provided by a human being or by an artificial intelligence model), and availability of a vertically integrated service. The user of the client device may select one or more of the connectivity packages according to their preference.

While it is known that ISPs can provide different packages (e.g., packages with different maximal uplink/downlink throughput, or packages with different maximal or minimal latencies) to their uses, the proposed concept is not limited to a single ISP. On the contrary, while the line/wire or radio access network connecting the gateway device to the ISPs is still operated by a single (or two, in case of multiple modems) ISP, the connectivity packages are provided on top of the line/wire or radio access network, as virtual tunnels having certain properties. In other words, the available connectivity packages may be provided by two or more internet service providers. The information on the available connectivity packages may be obtained, according to a geographic location, from a service for providing information on available connectivity packages of a plurality of internet service providers at a given location. For example, this service for providing the information on the available connectivity package may be provided by the ISP operating the line/wire or radio access network connecting the gateway device to the internet (via one or more ISPs).

The processor circuitry then selects one or more connectivity packages of the available connectivity packages for the data traffic of the client device. In most cases, the decision on which connectivity package(s) is selected is not performed by the gateway device. Instead, the selection may be performed upon instruction by the client device. In other words, the processor circuitry may obtain, from the client device, an instruction related to the selection of the one or more connectivity packages and select the one or more connectivity packages according to the instruction related to the selection of the one or more connectivity packages. The selection may thus be performed by the client device, either automatically, or according to an instruction of a user of the client device. To make the selection, the client device may be made aware of which connectivity packages are available for selection (i.e., at this particular gateway device). For example, the processor circuitry may provide the information on the available connectivity packages to the client device, and obtain the instruction related to the selection of the one or more connectivity packages in response to the provided information on the plurality of available connectivity packages.

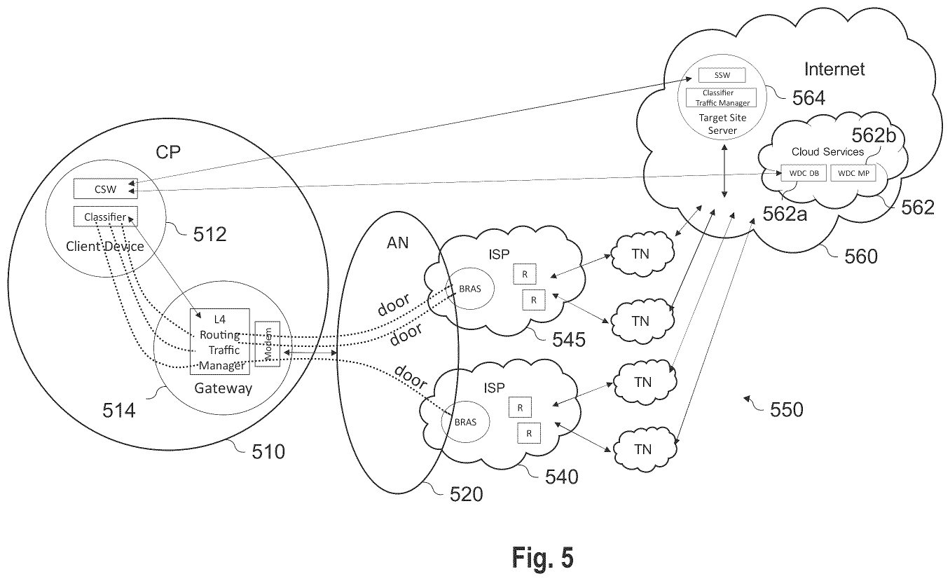

The selected one or more connectivity packages are then applied by establishing one or more connections being associated with the one or more connectivity packages. In general terms, each connectivity package may define a virtual connection or session between the gateway device and an endpoint of an internet service provider, which may correspond to the respective connection between the gateway device and the respective endpoint of the ISP. These connections are, in the present disclosure, also denoted “Internet Doors”. In FIG. 5, which gives an example of the proposed concept, the connection extends between the gateway 514 (i.e., the gateway device) and a BRAS (Broadband Remote Access Server, an endpoint of the ISP) of the ISP 540, 545, via an access network 520 being shared among the ISPs. Different techniques may be used to establish such (virtual) connections/sessions. For example, the processor circuitry may establish one of a separate tunnel (e.g., a Point to Point Protocol over Ethernet, PPPoE, tunnel, which may be seen as a tunnel above the Ethernet layer), a separate Internet Protocol (IP) destination (if the Dynamic Host Control Protocol, DHCP is used, which is not a tunnel but an end-point for a service provided by the ISP, e.g., Internet Protocol Television), a separate Virtual Local Area Network (VLAN, which may be seen as a tunnel within the Ethernet layer) or a separate Packet Data Unit (PDU, which may be seen as tunnel between the User Equipment, i.e., the gateway device, and the User Plane Function) session (in case a fifth generation (5G) cellular network according to the third-generation partnership project, 3GPP is used) to an endpoint of an internet service provider for each connectivity package being selected at the gateway device. These connection(s) may be established in addition to the basic connection (also denoted “basic Door” in the present disclosure) being provided by the ISP operating the wire/line or radio access network being used by the gateway device. In other words, the one or more connections associated with the selected one or more connectivity packages may be established in addition to a default connection between the gateway device and an endpoint of an internet service provider. For example, in some cases, more than one connection may be established (in addition to the basic connection) via the same modem of the gateway device. For example, the processor circuitry may establish a first connection between the gateway device and an endpoint of a service provider associated with a first connectivity package and a separate second connection between the gateway device and an endpoint of a service provider associated with a second connectivity package, with the first and second connection being established via the same modem of the gateway device.

The processor circuitry then routes the data traffic of the client device via one or more connections between the gateway device and a corresponding endpoint of the internet service provider associated with a respective connectivity package of the selected one or more connectivity packages. In some cases, e.g., if only one connection is established, all of the traffic may be routed via the one connection. Alternatively, a routing table may be used to route some traffic via one of the connection and other connection via another connection (e.g., even to route some traffic via the basic connection and some traffic via a connection associated with a connectivity package). To give an example: The instruction related to the selection of the one or more connectivity packages may define a connectivity package to be selected for data traffic of a specific application. The processor circuitry may route the data traffic of the specific application via the connection between the gateway device and the endpoint of the internet service provider associated with the selected connectivity package. This may be done separately for different applications. For example, the instruction related to the selection of the one or more connectivity packages may define a first connectivity package to be selected for data traffic of a first application and a second connectivity package to be selected for data traffic of a second application. The processor circuitry may route data traffic of the first application via a first connection between the gateway device and an endpoint of a service provider associated with a first connectivity package, and to route data traffic of the second application via a separate second connection between the gateway device and an endpoint of a service provider associated with a second connectivity package. For example, this may be implemented using a routing table, in which the different applications are identified by the ports being. The routing table may be defined using so-called 5-tuples (e.g., in Transmission Control Protocol/Inter Protocol, TCP/IP, the source IP address/port number, destination IP address/port number and the transport protocol in use), which may identify the application using the source IP address/port number combination being used by the client device and application. Moreover, in some cases, the Diffserv protocol may be used to assign packets to the one or more connections. Diffserv, or Differentiated Services, is a computer networking architecture protocol that specifies a mechanism for classifying and managing network traffic and providing quality of service (QoS) on modern IP networks. While a mapping between the QoS specified using the Diffserv protocol and the QoE being enabled by the different connectivity packages would be possible, in the present disclosure, the mapping between Diffserv QoS classification and the one or more connections may additionally take into account the source client device, as different client devices use different ones of the one or more connection. Accordingly, the processor circuitry may be configured to assign packets of different client devices to one of the one or more connections based on a Diffserv classification of the packets and based on a source of the respective packet.

In some cases, the user may be interested in experiencing a difference in experience between different connectivity packages to evaluate whether it is worth paying for a connectivity package. To enable such an evaluation, zapping, i.e., low effort switching between different connections may be enabled. For example, the instruction related to the selection of the one or more connectivity packages may define a first connectivity package and a second connectivity package to be selected for evaluating a difference between the first and second connectivity packages. The processor circuitry may switch between routing traffic of at least one application via a first connection associated with the first connectivity package and a second connection associated with the second connectivity package (e.g., upon command by the client device), to allow the client device to evaluate the difference between the first connectivity and the second connectivity package.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information. For example, the interface circuitry may comprise a modem for communicating via an access network of an ISP.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

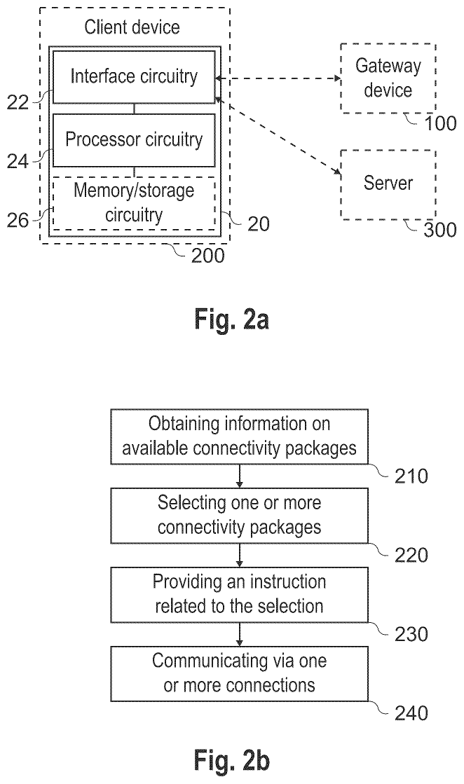

More details and aspects of the apparatus 10, device 10, gateway device 100, method and computer program are mentioned in connection with the proposed concept, or one or more examples described above or below (e.g., FIGS. 2a to 10c). The apparatus 10, device 10, gateway device 100, method and computer program may comprise one or more additional optional features corresponding to one or more aspects of the proposed concept, or one or more examples described above or below.

FIG. 2a shows a schematic diagram of an example of an apparatus 20 or device 20 for a client device 200. The apparatus 20 comprises circuitry to provide the functionality of the apparatus 20. For example, the circuitry of the apparatus 20 may be configured to provide the functionality of the apparatus 20. For example, the apparatus 20 of FIG. 2a comprises interface circuitry 22, processor circuitry 24, and (optional) memory/storage circuitry 26. For example, the processor circuitry 24 may be coupled with the interface circuitry 22 and/or with the memory/storage circuitry 26. For example, the processor circuitry 24 may provide the functionality of the apparatus, in conjunction with the interface circuitry 22 (for communicating with other entities inside or outside the client device 200), and the memory/storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIG. 2a comprises means for processing 24, which may correspond to or be implemented by the processor circuitry 24, means for communicating 22, which may correspond to or be implemented by the interface circuitry 22, (optional) means for storing information 26, which may correspond to or be implemented by the memory or storage circuitry 26. In general, the functionality of the processor circuitry 24 or means for processing 24 may be implemented by the processor circuitry 24 or means for processing 24 executing machine-readable instructions. Accordingly, any feature ascribed to the processor circuitry 24 or means for processing 24 may be defined by one or more instructions of a plurality of machine-readable instructions. The apparatus 20 or device 20 may comprise the machine-readable instructions, e.g., within the memory or storage circuitry 26 or means for storing information 26.

The processor circuitry 24 or means for processing 24 is to obtain information on available connectivity packages. The processor circuitry 24 or means for processing 24 is to select one or more connectivity packages of the available connectivity packages for data traffic of the client device. The processor circuitry 24 or means for processing 24 is to provide an instruction related to the selection of the one or more connectivity packages to a gateway device 100. The processor circuitry 24 or means for processing 24 is to communicate via one or more connections established by the gateway device. The one or more connections are established between the gateway device 100 and an endpoint of an internet service provider, with the one or more connections being associated with the selected one or more connectivity packages.

FIG. 2a further shows a client device 200 comprising the apparatus 20 or device 20. For example, the client device may be one of a mobile device, a smartphone, a wearable device, a tablet computer, a computer, a laptop computer, a desktop computer and a virtual reality, mixed reality or augmented reality device. In some examples, the client device 200 may form a system with the gateway device 100. For example, both FIGS. 1a and 2a show a system comprising the gateway device 100 and one or more client devices 200.

FIG. 2b shows a flow chart of an example of a corresponding method for a client device, e.g., the client device 200. The method comprises obtaining 210 the information on the available connectivity packages. The method comprises selecting 220 the one or more connectivity packages of the available connectivity packages for data traffic of the client device. The method comprises providing 230 the instruction related to the selection of the one or more connectivity packages to the gateway device. The method comprises communicating 240 via the one or more connections established by the gateway device. For example, the method may be performed by the client device 200, e.g., by the apparatus 20 or device 20 of the client device 200.

In the following, the functionality of the apparatus 20, device 20, client device 200, and of the corresponding method and a corresponding computer program will be introduced in more detail with respect to the apparatus 20 and client device 200. Features introduced in connection with the apparatus 20 and client device 200 may likewise be included in the corresponding device 20, method and computer program.

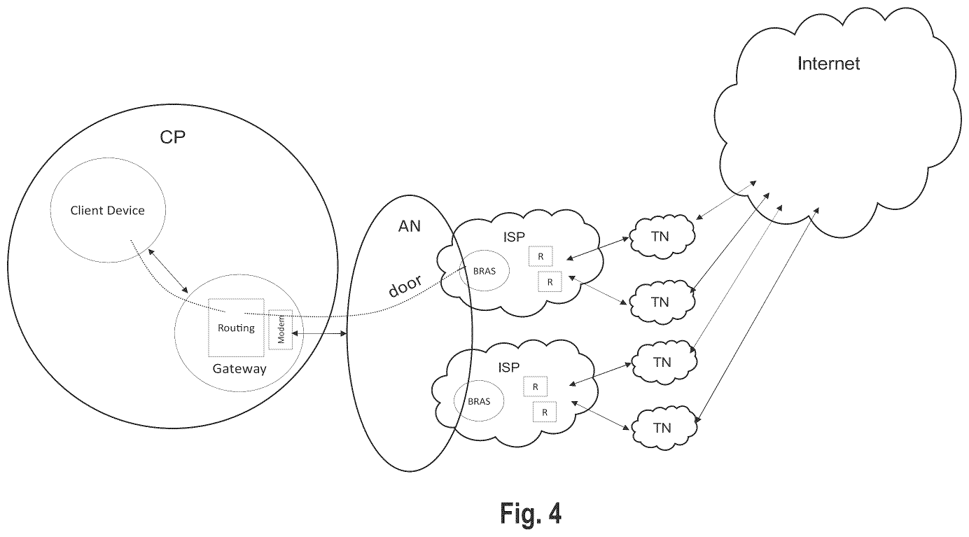

While the gateway device 100 discussed in connection with FIGS. 1a and 1b is responsible for establishing the one or more connections according to the selected one or more connectivity packages, selection of the one or more connectivity packages may be performed by or using the client device 200 discussed in connection with FIGS. 2a and 2b. For example, the functionality discussed in connection with FIGS. 2a and/or 2b may be performed by a software application. This software application is denoted CSW (Client Software) in connection with FIGS. 4 to 10c.

The basis for the selection of the one or more available connectivity packages is the information on the available connectivity packages, which may be obtained from various sources. For example, as discussed in connection with FIGS. 1a to 1b, the processor circuitry may obtain at least a portion of the information on the available connectivity packages from the gateway device. This portion of the information on the available connectivity packages may indicate, which connectivity packages have been advertised (e.g., by the ISP operating the wire/line or radio access network) towards the gateway device. This information is valuable for establishing a crowd-sourced database of which connectivity packages are available at which geographical location. Therefore, the processor circuitry may provide the information on the available connectivity packages to a crowd-sourced service (e.g., WDC-DB 562a introduced in connection with FIG. 5) for providing information about locally available connectivity packages. In addition to the mere availability of the connectivity packages, information about usage of the connectivity package(s) by the client device and information on a user rating of the connectivity package(s) may be provided to the crowd-sourced service. In other words, the processor circuitry may provide at least one of information on a usage of the selected one or more connectivity packages and information on a rating, such as information on a trust rating, information on a performance rating and/or information on a privacy ration, of the selected connectivity packages to the crowd-sourced service for providing information about locally available connectivity packages. For example, the processor circuitry may determine the information on the usage of the selected one or more connectivity packages automatically based on their usage, and to determine the information on the user rating based on an input of the user of the client device.

Apart from the gateway device, there are other sources for the information on the available connectivity packages. For example, the processor circuitry may obtain at least a portion of the information on the available connectivity packages from the crowd-sourced service for providing information about the locally available connectivity packages. For example, the information on the available connectivity packages obtained from the crowd-sourced service may comprise information on a usage of the respective connectivity package(s) by other users and/or information on a rating of the respective connectivity package(s) by other users, which may facilitate the selection of the one or more connectivity packages. Additionally, or alternatively, the processor circuitry may obtain at least a portion of the information on the available connectivity packages from an internet service provider-supplied service (e.g., WDC-MP 562b introduced in connection with FIG. 5), e.g., an online marketplace, for providing information about locally available connectivity packages. For example, the information on the available connectivity packages obtained from the internet service provider-supplied service may contain details about the respective connectivity package(s) and information about the costs and/or information on how the costs are charged with respect to the respective connectivity package(s).

The processor circuitry then selects one or more connectivity packages of the available connectivity packages for data traffic of the client device. For example, the processor circuitry may select the one or more connectivity packages based on one or more of a desired data throughput, a desired priority level, a desired latency, a desired transit network, a desired edge compute location, a desired edge compute capacity, a desired privacy level, a desired rating, a desired privacy rating, a desired trust rating, a desired performance rating, a desired level of use of artificial intelligence by services provided as part of or via the connectivity package, and a desired availability of a vertically integrated service. In some examples, the selection may be manual—the performance characteristics of the respective connectivity package(s) may be presented to the user of the client device, and the one or more connectivity packages may be selected based on an input of the user of the client device. Alternatively, the selection may be automatic according to one or more criteria set by the user, e.g., with respect to the desired data throughput, the desired priority level, the desired latency, the desired transit network, the desired edge compute location, the desired edge compute capacity, the desired privacy level, the desired rating, the desired privacy rating, the desired trust rating, the desired performance rating, the desired level of use of artificial intelligence by services provided as part of or via the connectivity package, and the desired availability of the vertically integrated service. In some examples, the selection may be automatic according to the device-type being used e.g. to enable one device/user to use one door, while another device/user to use a different door, thereby defining a policy-based scheme for the usage of doors.

Once at least one of the one or more connectivity packages are selected (which may be done iteratively), an instruction related to the selection of the one or more connectivity packages is provided to the gateway device, as discussed in connection with FIGS. 1a and/or 1b. For example, the instruction on the selection may identify the one or more connectivity packages being selected (and for which a connection is to be established), and one or more applications for which the respective connection(s) are to be used. For example, as outlined in connection with FIGS. 1a and/or 1b, in some cases, a connectivity package may be selected for one or more specific applications. In other words, the processor circuitry may select the one or more connectivity packages for a one or more applications. In this case, the instruction related to the selection of the one or more connectivity packages may define a connectivity package to be selected for data traffic of a specific application. As a result, data traffic of the one or more applications may be routed via the corresponding one or more connections established by the gateway device. For example, different connectivity packages may be selected for different applications. In other words, the processor circuitry may select a first connectivity package for a first application and a second connectivity package for a second application. In this case, the instruction related to the selection of the one or more connectivity packages may define the first connectivity package to be selected for data traffic of the first application and a second connectivity package to be selected for data traffic of the second application.

In some cases, a user may desire to “zap” between different connections to evaluate their performance. In this case, the instruction related to the selection of the one or more connectivity packages defines a first connectivity package and a second connectivity package to be selected for evaluating a difference between the first and second connectivity packages. For example, the processor circuitry may further provide a “switch” instruction to the gateway device, to trigger the gateway device to switch between routing data traffic via a first connection being associated with the first connectivity package and a second connection being associated with the second connectivity package. For example, the switch instruction may be provided in response to an input of the user of the client device, or automatically according to a timer.

Once the gateway device has been instructed, the processor circuitry communicates via the one or more connections established by the gateway device.

In some cases, the client devices may be connected to a further (i.e., different) gateway device, e.g., while travelling (e.g., in a hotel or airport), or at work. In these cases, the user may still prefer to communicate as the user is used to from the “home” gateway device, i.e., with the same performance characteristics. To achieve this, the processor circuitry may determine which connectivity packages are available at the further gateway device, and then instruct the further gateway device to establish one or more connections according to one or more connectivity packages that are the same (or similar) to the one or more connectivity packages being used at the “home” gateway device. For example, the processor circuitry may obtain, in case the client device is connected to the further gateway device, information on second available connectivity packages that are locally available at the further gateway device. The processor circuitry may select one or more connectivity packages of the second available connectivity packages according to a similarity of one or more connectivity packages to the one or more connectivity packages previously selected from the available connectivity packages that are locally available at the gateway device.

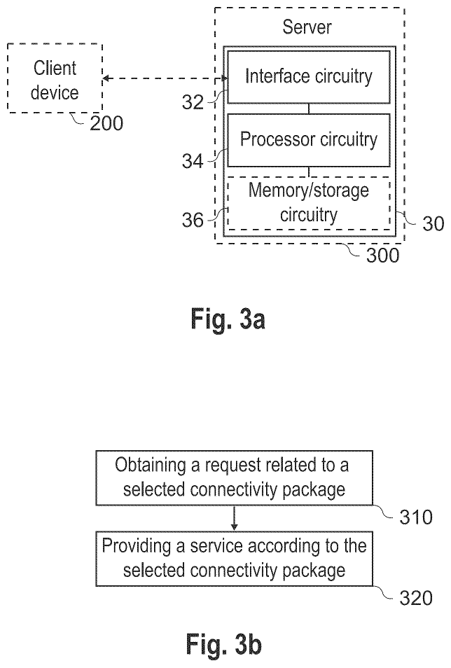

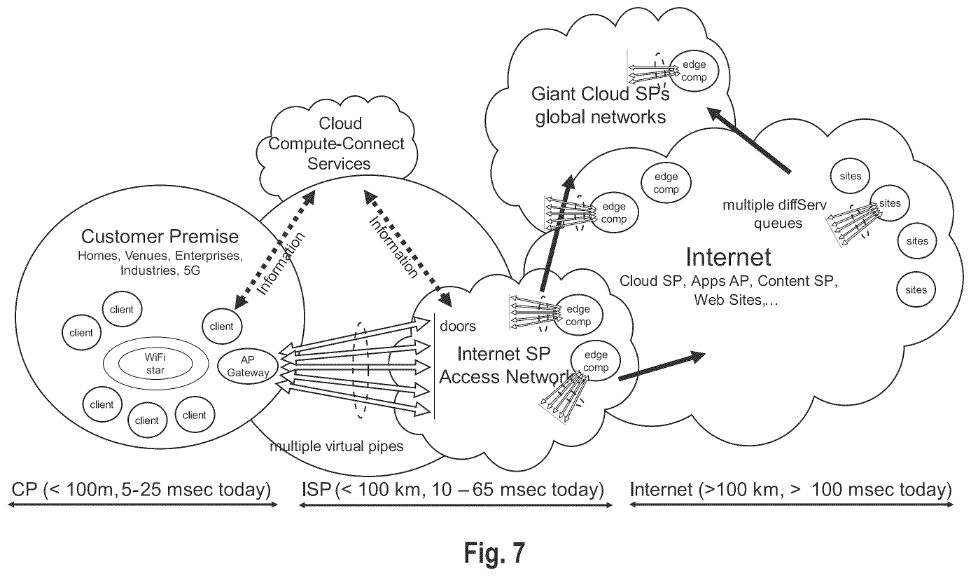

While the one or more connections being established by the gateway device have the performance characteristics desired by the user of the client device, the same cannot be guaranteed for the remainder of the respective connections between the client device and a server or service being used by the client device. For example, from traffic alone, the server or service might be unaware of the performance characteristics being desired by the user of the client device. Therefore, the client device may communicate with the server providing the service directly, to trigger the server to provide the service according to the selected one or more connectivity packages (and the performance characteristics of said connectivity packages). For example, the processor circuitry may provide a request related to a selected connectivity package to a server 300 (e.g., server 564 shown in FIG. 5). The request indicates at least one (performance) characteristic of the selected connectivity package, such that an end-to-end connection between the server and the client device may be established in line with the at least one characteristic of the selected connectivity package. This concept is illustrated in FIG. 7, where the sites and edge compute servers establish different connections (illustrated as arrows) towards the internet and/or the ISP, according to the connectivity package(s) selected by the client device. Some aspects of the present disclosure thus relate to a system comprising a client device 200 and a server 300. More information on this mechanism is discussed in connection with FIGS. 3a and/or 3b.

Moreover, to handle charging for the established connectivity package(s), the client device may document the usage of the one or more connectivity packages towards a charging server. In other words, the processor circuitry may provide information on the selection and/or a use of the one or more connectivity packages to a charging server. To establish a link between the client device and a corresponding account/payment information, an identification key may be used (denoted software key in connection with FIGS. 4 to 10c). Accordingly, the information on the selection and/or use of the one or more connectivity packages may comprise the identification key that is specific to the client device.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processor circuitry 24 or means for processing 24 may be implemented using one or more processing units, one or more processing devices, any means for processing, such as a processor, a computer or a programmable hardware component being operable with accordingly adapted software. In other words, the described function of the processor circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 26 or means for storing information 26 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 20, device 20, client device 200, method and computer program are mentioned in connection with the proposed concept, or one or more examples described above or below (e.g., FIG. 1a to 1c, 3a to 10c). The apparatus 20, device 20, client device 200, method and computer program may comprise one or more additional optional features corresponding to one or more aspects of the proposed concept, or one or more examples described above or below.

FIG. 3a shows a schematic diagram of an example of an apparatus 30 or device 30 for a server 300, and of a server 300 comprising such an apparatus 30 or device 30. The apparatus 30 comprises circuitry to provide the functionality of the apparatus 30. For example, the circuitry of the apparatus 30 may be configured to provide the functionality of the apparatus 30. For example, the apparatus 30 of FIG. 3a comprises interface circuitry 32, processor circuitry 34, and (optional) memory/storage circuitry 36. For example, the processor circuitry 34 may be coupled with the interface circuitry 32 and/or with the memory/storage circuitry 36. For example, the processor circuitry 34 may provide the functionality of the apparatus, in conjunction with the interface circuitry 32 (for communicating with other entities inside or outside the server 300), and the memory/storage circuitry 36 (for storing information, such as machine-readable instructions). Likewise, the device 30 may comprise means for providing the functionality of the device 30. For example, the means may be configured to provide the functionality of the device 30. The components of the device 30 are defined as component means, which may correspond to, or implemented by, the respective structural components of the apparatus 30. For example, the device 30 of FIG. 3a comprises means for processing 34, which may correspond to or be implemented by the processor circuitry 34, means for communicating 32, which may correspond to or be implemented by the interface circuitry 32, (optional) means for storing information 36, which may correspond to or be implemented by the memory or storage circuitry 36. In general, the functionality of the processor circuitry 34 or means for processing 34 may be implemented by the processor circuitry 34 or means for processing 34 executing machine-readable instructions. Accordingly, any feature ascribed to the processor circuitry 34 or means for processing 34 may be defined by one or more instructions of a plurality of machine-readable instructions. The apparatus 30 or device 30 may comprise the machine-readable instructions, e.g., within the memory or storage circuitry 36 or means for storing information 36.

The processor circuitry 34 or means for processing 34 is to obtain a request related to a selected connectivity package from a client device 200. The selected connectivity package is selected by the client device. The selected connectivity package is used to establish a connection between a gateway device used by the client device and a first endpoint of an internet service provider. The request indicates at least one characteristic of the selected connectivity package. The processor circuitry 34 or means for processing 34 is to provide a service for the client device according to the at least one characteristic of the selected connectivity package.

FIG. 3b shows a flow chart of an example of a corresponding method for a server, such as the server 300 shown in FIG. 3a. The method comprises obtaining 310 the request related to the selected connectivity package from the client device. The method comprises providing 320 the service for the client device according to the at least one characteristic of the selected connectivity package. For example, the method may be performed by the server 300, e.g., by the apparatus 30 or device 30 of the server 300.

In the following, the functionality of the apparatus 30, device 30, server 300, and of the corresponding method and a corresponding computer program will be introduced in more detail with respect to the apparatus 30 and server 300. Features introduced in connection with the apparatus 30 and server 300 may likewise be included in the corresponding device 30, method and computer program.

While the focus of the present disclosure is on the connection(s) being established between a gateway device and an endpoint of an ISP, to enable a client device to communicate via the connection(s) with a desired QoE, part of the QoE is not inherent to the connection(s) between the gateway device and the endpoint of the ISP, but by application servers and cloud servers providing the service(s) being consumed by the client device. Therefore, to enable or improve the end-to-end QoE between server providing the service and client device consuming the service, the client device may further instruct the server to provide its service according to the connectivity package(s) being selected by the client device. This process is implemented in the apparatus 30, device 30, method and computer program illustrated in connection with FIGS. 3a and 3b.

This process is started by the server obtaining, from the client device, the request related to the selected connectivity package. This request is used to inform the server about the connectivity package(s) being selected by the client device, which may indicate certain performance/QoE preferences by the client device. In particular, the request indicates at least one characteristic of the selected connectivity package, e.g., at least one characteristic of the selected connectivity package that is relevant to the provision of the service by the server and/or that is relevant for a connection between the server and the ISP. The server then provides the service for the client device according to the at least one characteristic of the selected connectivity package.

To give some examples: In some cases, a characteristic of the selected connectivity package may relate to the use of a transit network, a data throughput, and/or a latency. The server may then provide its service to the client device by establishing a connection to the ISP, e.g., a connection via the transit network specified by the selected connectivity package, a connection with the (minimal) data throughput specified by the selected connectivity package, a connection with the (maximal) latency specified by the selected connectivity package. In other words, the processor circuitry may establish a further connection between the server and a second endpoint of the internet service provider according to the at least on characteristic of the selected connectivity package. This is shown in FIG. 7, for example, where several servers maintain multiple connections (indicated by arrows) towards the ISP. If the characteristic of the selected connectivity package specifies the use of edge computing, then the server may at least partially offload providing the service to an edge compute server (e.g., according to an edge compute location and/or edge compute capacity specified by the selected connectivity package). If the characteristic of the selected connectivity package specifies a level of use of artificial intelligence by the service (e.g., a service provided by a human operator vs. a service provided by an AI-powered chatbot), the server may provide its service according to the level of use of artificial intelligence, e.g., by providing the service using an AI chatbot or based on input of a human operator. If the characteristic of the selected connectivity package specifies a priority level, the server may provide its service according to the priority level—by prioritizing (or not) the service being provided to the client device. If the characteristic of the selected connectivity package specifies a privacy level, the server may provide the service according to the specified privacy level, e.g., by determining whether to log activities and/or evaluate requests of the client devices for the purpose of building a user profile (e.g., for ad-targeting purposes). If the characteristic of the selected connectivity package specifies use of a vertically integrated service, then the server may prefer the use of ancillary services being provided by the same company operating the server. In summary, the at least one characteristic may comprise one or more of the group of a data throughput, a priority level, a latency, a transit network, an edge compute location, an edge compute capacity, a privacy level, and a level of use of artificial intelligence by the service, and a use of a vertically integrated service.

The interface circuitry 32 or means for communicating 32 may correspond to one or more inputs and/or outputs for receiving and/or transmitting information, which may be in digital (bit) values according to a specified code, within a module, between modules or between modules of different entities. For example, the interface circuitry 32 or means for communicating 32 may comprise circuitry configured to receive and/or transmit information.

For example, the processor circuitry 34 or means for processing 34 may be implemented using one or more processing units, one or more processing devices, any means for processing, such as a processor, a computer or a programmable hardware component being operable with accordingly adapted software. In other words, the described function of the processor circuitry 34 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 36 or means for storing information 36 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 30, device 30, server 300, method and computer program are mentioned in connection with the proposed concept, or one or more examples described above or below (e.g., FIG. 1a to 2b, 4 to 10c). The apparatus 30, device 30, server 300, method and computer program may comprise one or more additional optional features corresponding to one or more aspects of the proposed concept, or one or more examples described above or below.

Various examples of the present disclosure relate to a concept (e.g., a method) of creating multiple differentiated Internet access “doors” from any customer network over a single access modem of any type.

The present disclosure focuses on a method to selectively improve the user QoE by changing the network demarcation point between CP and AN. Today, this demarcation point is based on a single modem connectivity (e.g., xDSL (Digital Subscriber Line), Cable, Fiber, 5G(5^{th} Generation network according to the Third-Generation Partnership Project, 3GPP) to a single Internet Services Provider (ISP) over a single path via the AN. Today, ISPs usually offer a single experience to all types of usage and all ASPs.

FIG. 4 shows a schematic illustration of a contemporary Internet access scheme. FIG. 4 shows the CP network with a client device and a gateway (with a routing component and a modem), an AN (Access Network), ISPs with a Broadband Remote Access Server (BRAS) to which the routing component of the gateway connects via the modem and the AN, and different TNs to connect the ISPs to the Internet. ISPs offer a single user experience to all type of applications (indicated by the single “door” between the gateway and only one of the ISPs, while each application type benefits from different e2e network and compute resources to ensure high UX (user experience). For example, audio and video streaming applications may demand different latency & jitter conditions than browsing. When it comes to real-time interactivity video/audio, the demands may go even higher and may further increase for gaming applications. AR/VR applications demand strong and proximate compute power. A diverse set of applications demands diverse UX/QoE, which the current scheme offered by ISPs may not provide.

While ISPs can enable their infrastructure to support Diffserv, which may enable prioritization between traffic flows of different applications, the UX/QoE level goes beyond the prioritization of traffic flows. For example, offering different UX/QoE levels may provide the ability to provide different UX/QoE to traffic flows with the same Diffserv marking but with different (e.g., basis and premium, or multiple premium) service levels. Offering different UX/QoE levels may provide the ability to address additional UX aspects which are beyond network performance differentiation (such as bandwidth, throughput, latency, jitter). Such aspects may include transit networks type, edge compute power (e.g., in terms of capacity, availability, proximity), selectivity per usage/application type, on demand concurrent premium choices, privacy levels, artificial intelligence (AI) levels, vertical services availability, non-stop availability, and/or seamless operation. Additional aspects may become relevant in the future.

Today, as shown in FIG. 4, the CP is connected to a single ISP via a single constant path (e.g., a PPPoE (Point-to-Point Protocol over Ethernet) path), over a single modem connectivity to the AN, which is manually provisioned. In the following, this scheme is denoted a “single Internet access door”, which is the basic ISP offering today (“basic door”). Such a scheme restricts the ISP offering to a single UX/QoE for all type of usage/applications (e.g., all applications which are marked with same Diffserv marking get the same UX). In this scheme. the UX aspect is often considered at bandwidth-level only. Sometimes, the latency aspect (of about 30-50 msec) may be included as premium for gaming applications provided by the ISP or by a 3^{rd} party application-specific approach on top of the ISP. As a result, this scheme provides a limited, unrefined, non-adaptive connectivity service. Even if different ISPs provide different UX/QoE, a connectivity to more than one ISP may require a modem connectivity per each additional ISP. Thus, another problem is the ability to be connected to more than one ISP over the same modem. On top of that, the flexibility to identify, select and connect to a specific ISP while roaming does not exist, so even the chance to get the UX level a user prefers, or is used to, does not exist. In effect, the Internet is still an uncertain “black box” as far as UX is concerned.

Various examples of the present disclosure may enable ISPs to offer and provide multiple Internet access doors over a single modem. Each door provides a different user-experience level (UX level). A user's Client Software (CSW), at the user's device, may be used to discover, select and provision multiple doors on demand according to user's preferences per application type. The CSW may classify and/or direct an application traffic flow to the right door to gain the provided UX level.

The present disclosure may provide an end-2-end concept with a compute platform, to provide an e2e software framework that enables a top-notch end-user's experience. Various examples of the present disclosure provide a distributed software solution on Client-side and Server-side, with a user interface that configures user's preferences, and services transactions with ISPs.

The proposed concept enables ISPs to offer and provide multiple Internet access doors over a single modem. In the following, such ISPs will be called a “participating ISP”. Each door provides a different UX level. Each door may be published at the ISP portal per each door-ID, per each geographic location. User's Client Software (CSW), at the user's device, may discover, select and provision multiple doors on demand according to user's preferences per application type. The CSW may control the network from the edge according to what is being offered by the network rather than according to a complex signaling protocol or a central orchestration which cannot expect what the user expects on demands.

The user's preferences can be pre-configured and/or learned by the CSW over time. The CSW may classify and/or direct an application traffic flow to the right door to gain the provided UX. For example, the CSW may update a WW (World-Wide) doors Cloud Database (WDC-DB) about locally discovered doors. This may include information on an ISP portal, door-ID, door Geographic Location (DGL). The CSW may update the WDC-DB with information about the user's rating of the UX per application (e.g., with respect to quality and/or trust). The WDC-DB may keep a record per door that includes the door's usages volumes and ratings scores.

In some examples, the CSW may access, from everywhere while roaming, the WDC-DB to find and select a preferred local door for the user's preferred UX per application, using the user's preferences, the WDC-DB information on the ISP portal, door-ID, door Geographic Location (DGL), and the WDC-DB's per-door record, and then provisions and/or uses the selected door. For example, in a first option, manual door provisioning may be done by accessing the ISP portal using the information published at the ISP portal and the WDC-DB information on the ISP portal, door-ID, door Geographic Location (DGL). In a second option, automated door provisioning may be performed by the CSW using a WW doors Cloud Marketplace (WDC-MP) that may include the information published at the ISP portal and the WDC-DB information on the ISP portal, door-ID, door Geographic Location (DGL). In a third option, automated door provisioning may be performed by the CSW using an ISP portal, with a unified info-access across all participating ISPs, that include the information published at the ISP portal and the WDC-DB information on the ISP portal, door-ID, door Geographic Location (DGL).

UX aspects, provided by a door, may include one or more of the following ingredients: on demand multiple concurrent doors, zapping between doors, traffic specification & performance (bandwidth, Diffserv, latency), transit networks from the ISP, edge compute (e.g., location and capacity), concurrent doors from multiple ISPs, privacy levels (e.g., no tracking, no ads), Artificial Intelligence levels (e.g., up to human interactions), and/or vertical services availability.

Doors may be offered as premium on demand services in addition to the basic door. The charging may be covered by the ISP portal pr by the WDC-MP as part of options one to three illustrated above. The implementation at the ISP that ensures the provided UX-level is out of the scope of the present disclosure. For example, the ISP can evolve its network infrastructure to be sliced with transit/peering agreements with TNs to achieve UX-levels coverage.

FIG. 5 shows a schematic diagram of a network architecture that includes supports for multiple Internet access doors. FIG. 5 illustrates the main building blocks and relations, across the CP and the AN, which enables the multiple Internet access doors. The following entities are shown in FIG. 5. FIG. 5 shows the CP 510—the Customer Premises Network. FIG. 5 further shows a client device 512 in the CP, which may be any user's device that needs Internet access, at the CP network e.g., a PC (Personal Computer), Phone, TV (Television), smart home device, Gaming console, and more. The client device 512 includes the CSW—the Client-side Software (CSW) that controls the overall scheme and is installed at each user's device. The client device 512 further includes a classifier which is a part of the CSW that knows to classify application flows to preferred user's preferred doors/UX levels. The CP 510 further includes a gateway 514—the device that physically connects the CP 510 to the AN 520, and logically connects between the CP 510 and ISP 540, 545 or BRAS thereof. The gateway 514 includes an L4 (e.g., layer 4) routing component that is a part of the gateway that knows to route traffic flows from client devices into a specific door. The gateway 514 further includes a modem, which connects the CP 510 to the AN 520 with a single physical connection e.g., xDSL, Cable, Fiber, or 5G. FIG. 5 further shows the AN 520, which is the (single) Access Network to which all local ISPs are connected to reach the overall Internet. In some examples, multiple ANs may be supported by the modem (or modems). FIG. 5 further shows the ISP 540, 545 (two ISPs in this case)—the Internet Service Provider that connect the CP to the overall Internet. Each ISP 540, 545 includes a BRAS, a Broadband Remote Access Server, sometimes called BNG (Broadband Network Gateway), which terminates the logical connections from each CP, and one or more Rs, which are ISP routers within the ISP network that route traffic to the right TNs 550 according to a manageable policy of the ISP. FIG. 5 further shows the TNs 550 that serve the ISP and connect the ISP to the overall Internet with specific SLA (Service Level Agreement) terms. An ISP may be connected via multiple TN as required by its own planning FIG. 5 further shows the Internet 560. Cloud services 562 are provided via the Internet 560, which are hosted by a Cloud Services Provider (CSP), and which may include the Worldwide doors Cloud Database (WDC-DB) 564a and Marketplace (WDC-MP) 564b. One or more target site server 564 is further connected to the Internet 560. Each target site server 560 may include a Traffic Manage (TM), which may provide schemes of traffic queues and traffic bandwidth shapers and scheduler, where packet flows enter a queue according to its defined classification and exit from a queue according to a bandwidth shaper or a scheduler. An outgoing (upstream) queue and a shaper may be assigned to each door/UX-level. The target site server 562 may include a Server-Side Software (SSW) at the target website, that gets classification requests for packet flows from the CSW. The classification request may include the requested UX-levels for a packet flow.

For example, the following procedure may be applied. For example, the ISP 540, 545 may setup the offering of its doors to be discovered at the AN 520 by PPPoE discovery. The ISP may put the information on the ISP portal, door-ID, DGL to be discovered into the WDC-DB. Subsequently, the CSW may ask the Gateway 514 to discover the doors offered by ISPs across the AN 520. The gateway may use the PPPoE discovery and identify the offered services and reply to the CSW. For example, the BRAS connected to the AN may participate in the PPPoE discovery. For example, each or at least some BRAS may contain or offer multiple doors. For example, each ISP may have multiple BRAS on the same AN. For example, BRAS of different ISPs can reside on the same AN. For example, doors from multiple ISPs may be discoverable. The gateway 514 may keep (e.g., cache) this information for further queries by CSWs. The CSW may query the WDC-DB about the discovered doors, to extract the information on the ISP portal, door-ID, door Geographic Location (DGL), the information on the user's UX rating per application, and the door's usage volume and ratings scores. If this information exists, it may be presented to the user in case the door is manually selected (see the first option listed above). This might not be done for the automated second and third option. If the information does not exist, the CSW may update the WDC-DB with the discovered doors.

The user may select the relevant doors for each “application category” (e.g., Video conferencing, gaming, browsing, streaming etc. The CSW may store the user preferences over time and may suggest the user to enable seamless automated selection (a learning method, which is out of scope of the present disclosure). If the door is manually selected (first option), the user may check the ISP portal for purchase and credential information for each of the doors and provide this information to the CSW. For the second and third automated options, this procedure may be done automatically. For example, the CSW may access the WDC-MP, purchase access to the door and obtain credential information for each of the doors. The ISPs may register themselves with their doors offering and automated credential generation at the WDC-MP. Users may have an account in the WDC-MP to enable their CSW purchase and obtain credentials on their behalf.

The CSW asks the Gateway to provision the doors, e.g., via the PPPoE establishment procedure using the credential it obtained for the specific door. Such provisioning may include the TM (Traffic Manager) assignment of outgoing queue and shaper to each door/PPPoE according to the door's bandwidth specification by the ISP. Such provisioning may include a mapping table between the DSCP (Differentiated Services CodePoint, for Diffserv) marking to the IEEE (Institute of Electrical and Electronics Engineers) 802.1p marking of the PPPoE layer.

When the user starts using a specific application, the CSW may identify the “application category” and its 5-tuple (e.g., in Transmission Control Protocol/Inter Protocol, TCP/IP, the source IP address/port number, destination IP address/port number and the protocol in use), classifies it to the right door and sets a Gateway L4 routing 5-tuple entry. This may ensure that the application flow will reach the right door. The CSW may control the classifier at the client device to DSCP mark the traffic flow according to a combination of the application request (if there's such request), a preconfigured mapping rule for each “application category”, a recommendation of the ISP for a specific door, and a relative rule across all currently open doors at the CP. This internals combination may be configurable and outside the scope of this document beside the existence of such combination method.

The CSW may send a request to the SSW of the target-site-server, with the UX-levels for the 5-tuple of the traffic flow. The CSW may use the request to set the TM (Traffic Manager) assignment for the specific traffic flow but may also pass to an upper API (Application Programming Interface) additional UX ingredients such as a privacy level and an AI level for the traffic flow. The TM at the target-site-server may be set by the SSW in an aggregated manner across incoming UX-levels/doors, of all kinds globally, into the target-site-server. This aggregation method may be outside the scope of this document, beside the existence of such method.

The gateway routes traffic flows into corresponding doors according to its L4 routing. It may use the TM provisioning (the TM assignment of outgoing queue and shaper to each door/PPPoE according to the doors bandwidth specification by the ISP) and marking (mapping table between the DSCP marking to the 802.1p marking of the PPPoE layer). The ISP handles the incoming door traffic according to its UX offering for each door.

The CSW may ask the user to rate the experience of using the door and update the WCD-DB with the rating for the “application category” under the specific door.

The CSW may scan the user's usage to identify when the user application ceases to operate and may then ask the Gateway to delete the L4-routing entry. If this also the last application using the specific door, the CSW may ask the Gateway to terminate the door via the PPPoE termination procedure.

The ISP may charge the user according to the model mentioned in the ISP portal or WDC-MP. The ISP can measure the usage duration of a door from provisioning to termination.

In the following, some aspects are discussed to enable the CSW as a service. For example, the CSW may be pre-installed by an OEM (Original Equipment Manufacturer), installed by an Enterprise IT (Information Technology) department, installed by a 3rd-party who provides services to users, or installed by the “primary ISP” of a user (here “primary ISP” is the ISP that provides the gateway to the user. The CSW may be enabled by a “SW-key” provided as a service by the “CSW provider” (e.g., an equipment manufacturer or network infrastructure provider). The CSW may enable the door's business of the ISPs. An ISP may obtain a specific “SW-key” per user, from the “CSW provider”, to activate the CSW on a user device, and by that activates the doors business. Once the CSW is being activated by a “SW key”, each time a door is provisioned, the CSW may update the WDC-DB about a usage of the “SW key” using the information on the ISP portal, door-ID, DGL. The “CSW provider” can associate this info with the WDC-MP to evaluate the usage of the CSW as a service by each ISP. This can provide a baseline to calculate the revenue stream from each ISP. The calculation is outside the scope of the present disclosure. ISPs can transfer “SW keys” to Enterprise-IT or to 3^{rd}-party service providers.

An aspect of the present disclosure relates to the overall concept of Internet doors. An aspect of the present disclosure relates to the ability of the CSW to control the network from the edge. An aspect of the present disclosure relates to a build-up of the WDC-DB out of data collected locally by the CSW. An aspect of the present disclosure relates to the usage of the WDC-DB for roaming. An aspect of the present disclosure relates to the usage of the WDC-DB for selecting doors according to usage volume and rating. An aspect of the present disclosure relates to the doors overall UX ingredients. An aspect of the present disclosure relates to the UX ingredient of Privacy and the trust rating. An aspect of the present disclosure relates to the UX ingredient of AI levels. An aspect of the present disclosure relates to the UX ingredients of doors zapping. An aspect of the present disclosure relates to the client-side to server-side control. An aspect of the present disclosure relates to the marking combinations by the CSW. An aspect of the present disclosure relates to the WDC-MP. An aspect of the present disclosure relates to the “SW key” as the enabler of providing the CSW as a Service. An aspect of the present disclosure relates to the support for multiple doors and multiple ISPs over a single modem. An aspect of the present disclosure relates to the ability to run the CSW on any user's device. An aspect of the present disclosure relates to the ability to adapt the concept to any modem type.

Various aspects of the present disclosure relate to the software layer and protocols, that connect between end-to-end compute assets (client & servers) across the web, from client-side via edge-server to cloud-servers to provide a higher, on-demand premium user experience, by implementing multiple Internet access doors each delivering different premium user experience.

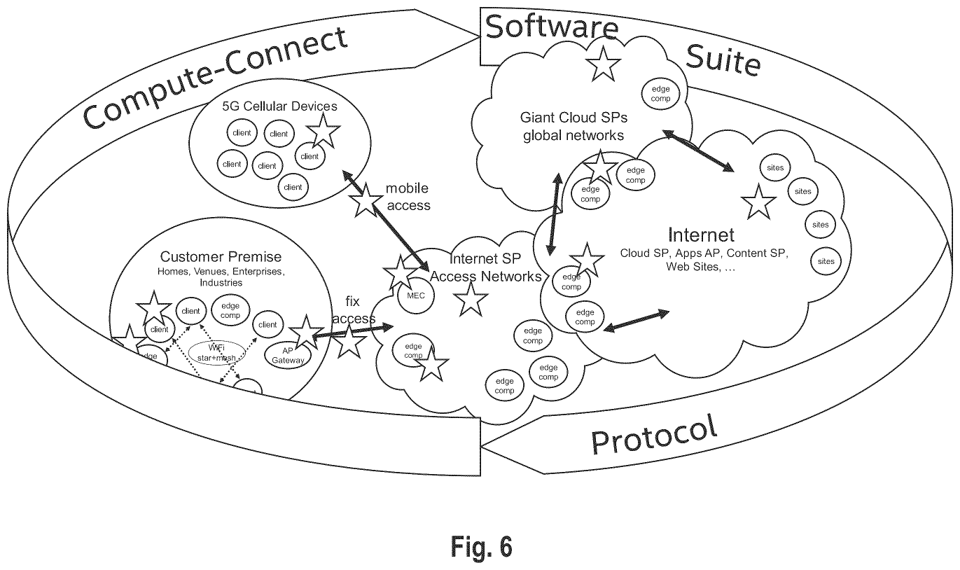

FIG. 6 shows different components and software being involved in some examples of the present disclosure. For example, the proposed concept may affect the customer premise (such as homes, venues, enterprises or industries), with clients, edge compute entities, gateways etc., 5G cellular devices (clients), ISP access networks (with edge compute entities), the Internet (with Cloud SPs, Application SPs, Content SPs, web sites etc., including sites and edge compute entities) and giant Cloud SPs global networks.

FIG. 7 shows a schematic illustration of using multiple doors via multiple virtual pipes, at the client network and at the edge-servers and cloud servers, across various data centers within main global networks authorities' segments. As is evident from FIG. 7, multiple doors (i.e., virtual pipes) may not only be used between the access point gateway of the customer premises and the ISP, but also between edge computing entities and the ISP, web sites and the internet, and giant Cloud CPS and their global networks.

The access to the doors is implemented at the components along the path at the software layer—at the user-access-side (e.g., PC & home-gateway) and at the server-access-side (e.g., near-edge, far-cloud). It enables Tier-1 Internet Service Providers (Tier-1 ISPs) to offer such premium doors to users, on demand, where users devices (enabled by the software layer of the proposed concept) can autonomously classify and route specific application's traffic to the right access door that will provide the user-experience as selected by the user for that application and its context (e.g., who use the application, when, and so forth), on-demand during the lifetime of the application.

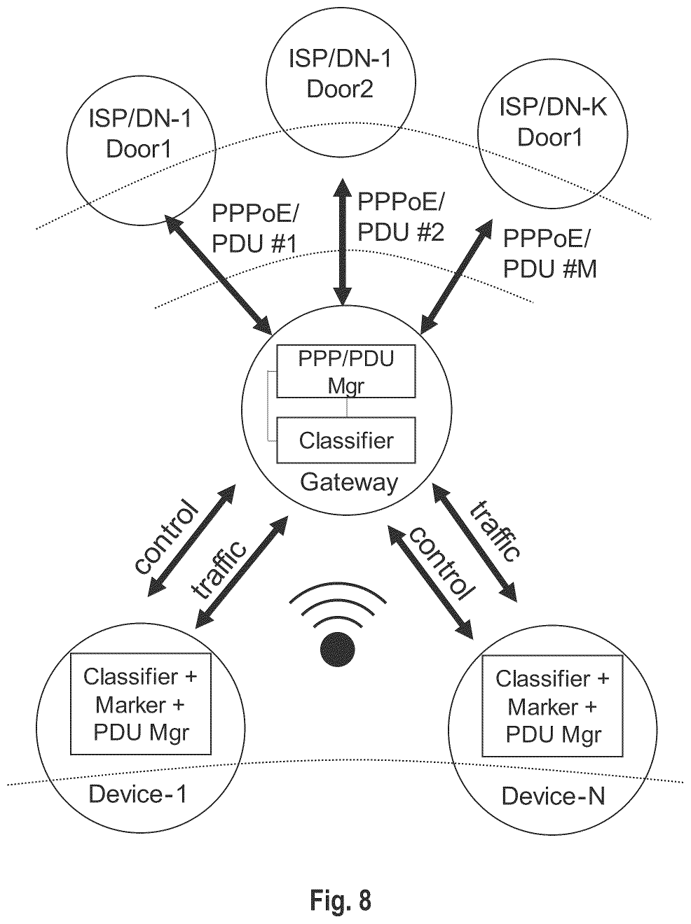

FIG. 8 shows a schematic diagram that illustrates an interaction between the gateway, the client devices, and the ISP doors. FIG. 8 shows the classification/routing components at the client device (e.g., users' PC) and at the gateway of the client's network (e.g., home-router/gateway) toward the virtual ISP pipes, which are the access doors (e.g., PPPoE tunnel over wired xDSL or Fiber or Cable, or PDU/5G over cellular). The gateway includes a PPP/PDU manager and a classifier and maintains PPPoE PDUs to the ISP doors. On the other hand, the gateway exchanges traffic and control information with the client devices, e.g., with a classifier, marker and PDU manager of the respective client devices. A software layer implementation of the proposed concept may be responsible for opening these virtual ISP pipes (the access doors) and the traffic classification and routing via these pipes (the access doors).

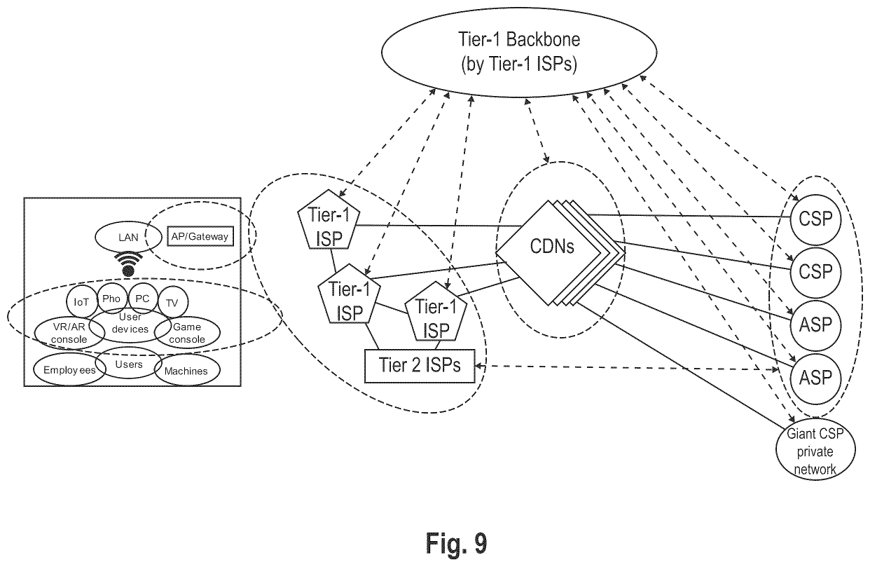

How Tier-1 ISPs will engineer the end-to-end QoE and route the traffic, is outside the scope of the present disclosure. The present disclosure focuses on 1) offering the access doors by Tier-1 ISPs and enabling them to offer a rich variety of access doors, 2) the software layer to autonomously classify and route application's traffic to the access doors, 3) the handshake between the components along the path to enable it in an end-to-end manner, 4) extending the coverage of “user experience” beyond just network performance, and 5) additional capabilities that make it seamless and available everywhere. There are enough existing capabilities for Tier-1 ISPs to leverage their peering relationship with other Transit Networks, via existing infrastructure investments and standard protocols, to implement the proposed concept (see FIG. 9). However, the present network architecture lacks a smart demarcation access point with users and applications, which is the focus of the proposed concept.

FIG. 9 gives an overview of the network industry ecosystem. On the left, the customer premises network is shown, with various client devices, a Local Area Network, and an Access Point/Gateway. Various user devices/applications are shown, even beyond just PCs, which may be provided a premium experience using the doors. To the left, the ISPs are shown, which may connect to Tier-1-ISPs of the backbone of the internet (shown on top). The ISPs connect to CDNs (Content Delivery Networks), and via the CDNs (or directly) to the CSPs, ASPs (e.g., internet sites), and private networks of giant cloud CSPs. All devices are interconnected. For example, to reach an ASP, an ISP does not necessarily use a CDN, but can pass the Tier-1 backbone. To give an example, a tier-1 ISP, can reach the private network of a giant cloud CSP via its own Tier-1 backbone, and use the giant cloud CSP's content services or applications services from the private network of the giant cloud CSP.

No matter how many doors user consumes, even from multiple ISPs, it may be accessible via a single physical connection type (e.g., xDSL, Cable, Fiber, 5G). Each door may offer a different experience with rich ingredients, much beyond just networking performance (e.g., beyond the known Diffserv), as specified above. The proposed concept may be used to provide a software layer to Tier-1 ISPs, enabling them to offer premium doors services to end-users via a “software as a service” (SaaS) model, which may be unlock or installed by the proposed software layer, of the proposed concept, on user's PCs/devices, and charged as a service.

The proposed concept may enable users/applications to concurrently, on-demand, access multiple doors of multiple ISPs. In addition, the proposed concept may offer a roaming solution to discover and connect to same doors' experiences, as experienced by users and known to them in their home-zone, while roaming to a different geographical zone (e.g., hotels). In addition, the proposed concept may enable marketplace of doors, where users can give rating to ISPs' doors and select ISPs' doors according to their ratings. There are two types of rating—“trust rating” which is dedicated to privacy, and “quality rating” which relate to the overall quality of experience. In addition, the proposed concept may enable users to zap between doors, on-the-fly while using an application. This enables the user to try and experience the quality-difference between doors, for a specific usage/application, and select the best that cost-effectively fits the need. The proposed concept may enable differentiated QoS for each workload.

The proposed concept is compatible with different types of physical access demarcation-xDSL, Cable, Fiber, 5G. It leverages the L2/L3 capabilities above these physical access types. For xDSL and Fiber, it may leverage the capabilities of PPPoE, where each access door will have separate PPPoE over the same physical layer. In Cable, it may leverage the Dynamic Host Configuration Protocol (DHCP) or PPPoE. Some ISPs use DHCP and some PPPoE. In case of PPPoE it's the same as for xDSL and Fiber. In case of DHCP, each access door may have a separate BRAS IP-address. For 5G, it may leverage a separate PDU for each access door. These examples provide means of implementing the access doors on top of the four existing and popular physical access method.

5G slicing is a 5G infrastructure that can be leveraged to implement the access doors, as mentioned above. The proposed concept may leverage 5G/PDU, at the 5G/UE (User Equipment), to implement access doors. The software layer may be unlocked/installed on the 5G/UE device.

The focus of the present disclosure is on the access doors across various components along the path (client and servers) handshaking together using the software layer at each component. The present disclosure is based on a “quality of experience” in addition to just “quality of service”. In addition to extended Diffserv capabilities, it may cover ingredients like one or more of edge compute power levels, artificial intelligence levels, privacy levels, transit network types, context, availability of vertical services by specialized wholesale-ISPs (e.g., customers of the Tier-1 ISP). These can be evolved to many additional ingredients in the future.

To give an example: To participate in a wedding abroad using virtual reality, while sitting on the sofa at home, since the viewer is unable to take multiple days of for two hours of wedding, a door may be booked as a service to provide an improved experience, which surpasses the experience of using the “basic door”. The proposed service may be based on an access door of an ISP specializing in providing such service. This might be a Tier-2 or Tier-3 ISP, which is a customer of the Tier-1 ISP via its wholesale-ISP services to smaller ISPs. Such a service may require edge compute capacity—the ISP may offer several edge-compute capacity levels for different levels of experience with different prices. Such a service may be provided with embedded ads (personalized ads) or without embedded ads at all. This can be offered, for example, by different privacy levels. Such a service can be offered by using a global transit network of one or more giant Cloud SPs (each with different peering agreements of the Tier-1 ISP), and with each providing different experience with different prices. Such a service can be offered in parallel to another VR service to the same household, but with different importance (different context) e.g., a concurrent “VR gaming application” may access a different access door than the “wedding VR application”, providing different level of experience to each, per the household preference, although both are live-VR sessions.

The proposed concept may enable Tier-1 ISPs to offer rich access doors, engineered for users/applications to select on demands, using the proposed software layer, rather than creating a signaling protocol from users' devices across the whole network end-to-end. This is a huge simplification which enables opportunities for Tier-1 ISPs, enabling them to recoup costs of their current and future network investments.

The proposed concept may leverage existing protocols like PPPoE, DHCP and 5G/PDU, in order to establish doors on demand. A protocol is provided to establish a handshake between the different components, from user's device (e.g., Laptop) to the far-end server that host the web-application, to deliver the door ID, and its experience ingredients, for a specific traffic flow (the 5-tupples of the flow).

Another unique control-protocol here is provided between the user's device (e.g., Laptop) and the home router/gateway of the Tier-1 ISP that connect the customer home-network to the Tier-1 ISP network via modem (xDSL, Fiber, Cable, 5G). This protocol instructs the router/gateway to open a specific door, on demand, and which traffic flows to route via this door (via the 5-tupples of the flows). FIG. 8 shows the software functionality at the user-device and at the home router/gateway.

The detailed specification of these protocols can be an extension to existing protocols, like NETCONF/YANG used in Web-Based-Management of Network Elements. The routing of packet flows across the network may be done by the Tier-1 ISP and its peering Transit Networks, using the routing protocols of its authority domain, but leveraging the quality-of-experience specification of the specific access-door. For example: a Tier-1 ISP may have several interfaces to its peering Transit Network—some that cope with several doors' specifications (premium peering), and some that do not (low-cost or free peering). For example: Some that ensure privacy (personal ads free) and some that do not. Some that are directly connected to a near “Virtual Reality compute-edge farm”, and some that are not.

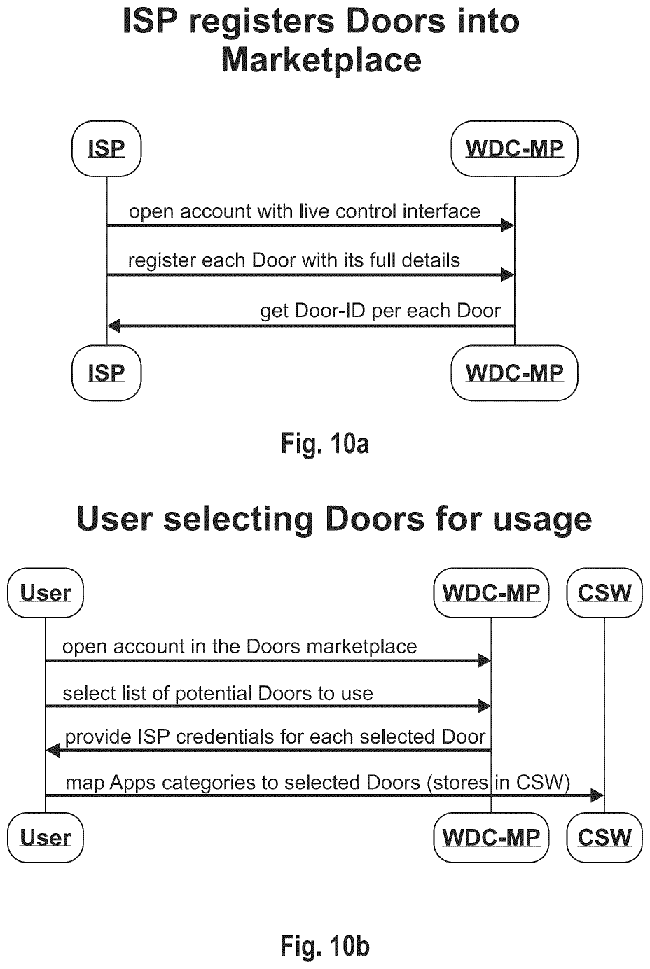

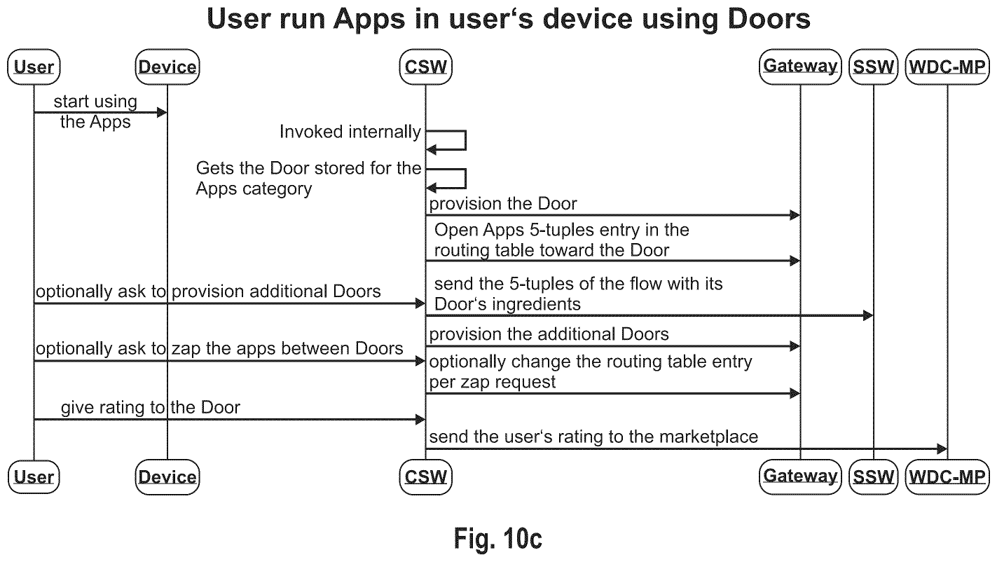

In FIGS. 10a to 10c, flows are shown for various processes described herein. While each flow may include more details and possibilities, these flows illustrate main value, components, and procedure of the proposed concept. FIG. 10a is a flow diagram of an example flow of an ISP registering one or more doors into a marketplace (i.e., the WDC-MP). The flow starts with the ISP opening an account with a live control interface at the WDC-MP, followed by registering each door with its full details. The ISP then retrieves, for each door, a door-ID (identifier).

FIG. 10b is a flow diagram of an example flow of a user selecting one or more doors for usage. Initially, the user opens an account in the doors marketplace (WDC-MP) and selects a list, at the WDC-MP, of potential doors to use. The WDC-MP then provides ISP credentials for each selected door to the user. The user then maps apps categories to selected doors and stores the information in the CSW.

FIG. 10c is a flow diagram of an example flow of a user running applications on the user's device using doors. The flow starts with the user starting using the apps on the device. The CSW is invoked internally on the device, and retrieves the door stored for the apps' category. The CSW then contacts the gateway to provision the door, open the apps' 5-tuple entry in the routing table toward the door (at the gateway), and sends the 5-tuples of the follow with its door's ingredients to the SSW. Optionally, when the user asks the CSW to provision additional doors, th CSW requests the gateway to provision the additional doors. Optionally, when the user asks the CSW to zap the apps between the doors, the CSW changes the routing table entry per zap request. When the user gives a rating for a door (at the CSW), the CSW sends the user's rating to the marketplace (WDC-MP).

The proposed concept enables premium services of the future with new business models e.g., VR real time services (live sports, shows, private event), privacy, multiple concurrent service providers, roaming of user experience levels, and many more.

In the following, some examples of the proposed concept are presented:

An example (e.g., example 1) relates to an apparatus (10) for a gateway device (100, 514), the apparatus comprising interface circuitry (12), machine-readable instructions, and processor circuitry (14) to execute the machine-readable instructions to obtain information on a plurality of available connectivity packages, with each connectivity package defining a connection between the gateway device and an endpoint of an internet service provider (540, 545), and with each connectivity package being characterized by one or more connection performance parameters, select one or more connectivity packages of the available connectivity packages for data traffic of a client device (200, 512), and route the data traffic of the client device via one or more connections between the gateway device and a corresponding endpoint of the internet service provider associated with a respective connectivity package of the selected one or more connectivity packages.

Another example (e.g., example 2) relates to a previous example (e.g., example 1) or to any other example, further comprising that the available connectivity packages provide different user experiences, as defined by the respective one or more connection performance parameters.

Another example (e.g., example 3) relates to a previous example (e.g., one of the examples 1 or 2) or to any other example, further comprising that the available connectivity packages are provided by two or more internet service providers.

Another example (e.g., example 4) relates to a previous example (e.g., one of the examples 1 to 3) or to any other example, further comprising that the information on the available connectivity packages is obtained, according to a geographic location, from a service for providing information on available connectivity packages of a plurality of internet service providers at a given location.

Another example (e.g., example 5) relates to a previous example (e.g., one of the examples 1 to 4) or to any other example, further comprising that the plurality of different connectivity packages differ with respect to one or more performance characteristics of the group of data throughput, priority level, latency, transit network, edge compute location, edge compute capacity, privacy level, rating, privacy rating, trust rating, performance rating, level of use of artificial intelligence by services provided as part of or via the connectivity package, and availability of a vertically integrated service.

Another example (e.g., example 6) relates to a previous example (e.g., one of the examples 1 to 5) or to any other example, further comprising that the processor circuitry is to execute the machine-readable instructions to establish one of a separate tunnel, a separate Internet Protocol (IP) destination, a separate Virtual Local Area Network (VLAN) or a separate Packet Data Unit (PDU) session to an endpoint of an internet service provider for each connectivity package being selected at the gateway device.

Another example (e.g., example 7) relates to a previous example (e.g., example 6) or to any other example, further comprising that the tunnel is a Point-to-Point Protocol over Ethernet, PPPoE, tunnel.

Another example (e.g., example 8) relates to a previous example (e.g., one of the examples 1 to 7) or to any other example, further comprising that the processor circuitry is to execute the machine-readable instructions to obtain, from the client device, an instruction related to the selection of the one or more connectivity packages and select the one or more connectivity packages according to the instruction related to the selection of the one or more connectivity packages.

Another example (e.g., example 9) relates to a previous example (e.g., example 8) or to any other example, further comprising that the instruction related to the selection of the one or more connectivity packages defines a connectivity package to be selected for data traffic of a specific application, wherein the processor circuitry is to execute the machine-readable instructions to route the data traffic of the specific application via the connection between the gateway device and the endpoint of the internet service provider associated with the selected connectivity package.

Another example (e.g., example 10) relates to a previous example (e.g., example 9) or to any other example, further comprising that the instruction related to the selection of the one or more connectivity packages defines a first connectivity package to be selected for data traffic of a first application and a second connectivity package to be selected for data traffic of a second application, wherein the processor circuitry is to execute the machine-readable instructions to route data traffic of the first application via a first connection between the gateway device and an endpoint of a service provider associated with a first connectivity package, and to route data traffic of the second application via a separate second connection between the gateway device and an endpoint of a service provider associated with a second connectivity package.

Another example (e.g., example 11) relates to a previous example (e.g., one of the examples 8 to 10) or to any other example, further comprising that the processor circuitry is to execute the machine-readable instructions to provide the information on the available connectivity packages to the client device, and wherein the instruction related to the selection of the one or more connectivity packages is based on the provided information on the plurality of available connectivity packages.

Another example (e.g., example 12) relates to a previous example (e.g., one of the examples 8 to 10) or to any other example, further comprising that the instruction related to the selection of the one or more connectivity packages defines a first connectivity package and a second connectivity package to be selected for evaluating a difference between the first and second connectivity packages, wherein the processor circuitry is to execute the machine-readable instructions to switch between routing traffic of at least one application via a first connection associated with the first connectivity package and a second connection associated with the second connectivity package, to allow the client device to evaluate the difference between the first connectivity and the second connectivity package.

Another example (e.g., example 13) relates to a previous example (e.g., one of the examples 1 to 12) or to any other example, further comprising that the processor circuitry is to execute the machine-readable instructions to establish a first connection between the gateway device and an endpoint of a service provider associated with a first connectivity package and a separate second connection between the gateway device and an endpoint of a service provider associated with a second connectivity package, with the first and second connection being established via the same modem of the gateway device.

Another example (e.g., example 14) relates to a previous example (e.g., one of the examples 1 to 13) or to any other example, further comprising that each connectivity package defines a virtual connection or session between the gateway device and an endpoint of an internet service provider.

Another example (e.g., example 15) relates to a previous example (e.g., one of the examples 1 to 14) or to any other example, further comprising that the one or more connections associated with the selected one or more connectivity packages is established in addition to a default connection between the gateway device and an endpoint of an internet service provider.

Another example (e.g., example 16) relates to a previous example (e.g., one of the examples 1 to 15) or to any other example, further comprising that the processor circuitry is configured to assign packets of different client devices to one of the one or more connections based on a Diffserv classification of the packets and based on a source of the respective packet.

An example (e.g., example 17) relates to an apparatus (10) for a gateway device (100), the apparatus comprising processor circuitry (14) configured to obtain information on a plurality of available connectivity packages, with each connectivity package defining a connection between the gateway device and an endpoint of an internet service provider, and with each connectivity package being characterized by one or more connection performance parameters, select one or more connectivity packages of the available connectivity packages for data traffic of a client device (200), and route the data traffic of the client device via one or more connections between the gateway device and a corresponding endpoint of the internet service provider associated with a respective connectivity package of the selected one or more connectivity packages.

An example (e.g., example 18) relates to a device (10) for a gateway device (100), the device comprising means for processing for obtaining information on a plurality of available connectivity packages, with each connectivity package defining a connection between the gateway device and an endpoint of an internet service provider, and with each connectivity package being characterized by one or more connection performance parameters, selecting one or more connectivity packages of the available connectivity packages for data traffic of a client device, and routing the data traffic of the client device via one or more connections between the gateway device and a corresponding endpoint of the internet service provider associated with a respective connectivity package of the selected one or more connectivity packages.

An example (e.g., example 19) relates to a method for a gateway device (100), the method comprising obtaining (110) information on a plurality of available connectivity packages, with each connectivity package defining a connection between the gateway device and an endpoint of an internet service provider, and with each connectivity package being characterized by one or more connection performance parameters, selecting (120) one or more connectivity packages of the available connectivity packages for data traffic of a client device, and routing (130) the data traffic of the client device via one or more connections between the gateway device and a corresponding endpoint of the internet service provider associated with a respective connectivity package of the selected one or more connectivity packages.

Another example (e.g., example 20) relates to a gateway device (100, 514) comprising the apparatus or device according to one of the examples 1 to 18 (or according to any other example).

Another example (e.g., example 21) relates to a gateway device (100, 514) to perform the method of example 19 (or according to any other example).

An example (e.g., example 22) relates to an apparatus (20) for a client device (200, 512), the apparatus comprising interface circuitry (22), machine-readable instructions, and processor circuitry to execute the machine-readable instructions to obtain information on available connectivity packages, select one or more connectivity packages of the available connectivity packages for data traffic of the client device, provide an instruction related to the selection of the one or more connectivity packages to a gateway device (100, 514), and communicate via one or more connections established by the gateway device, with the one or more connections being established between the gateway device (100) and an endpoint of an internet service provider (540, 545), the one or more connections being associated with the selected one or more connectivity packages.

Another example (e.g., example 23) relates to a previous example (e.g., example 22) or to any other example, further comprising that the processor circuitry is to execute the machine-readable instructions to obtain at least a portion of the information on the available connectivity packages from the gateway device.

Another example (e.g., example 24) relates to a previous example (e.g., one of the examples 22 or 23) or to any other example, further comprising that the processor circuitry is to execute the machine-readable instructions to obtain at least a portion of the information on the available connectivity packages from a crowd-sourced service for providing information about locally available connectivity packages.

Another example (e.g., example 25) relates to a previous example (e.g., one of the examples 22 to 24) or to any other example, further comprising that the processor circuitry is to execute the machine-readable instructions to obtain at least a portion of the information on the available connectivity packages from an internet service provider-supplied service (562b) for providing information about locally available connectivity packages.

Another example (e.g., example 26) relates to a previous example (e.g., one of the examples 22 to 25) or to any other example, further comprising that the processor circuitry is to execute the machine-readable instructions to provide the information on the available connectivity packages to a crowd-sourced service (562a) for providing information about locally available connectivity packages.

Another example (e.g., example 27) relates to a previous example (e.g., example 26) or to any other example, further comprising that the processor circuitry is to execute the machine-readable instructions to provide at least one of information on a usage of the selected one or more connectivity packages and information on a rating, such as information on a trust rating, information on a performance rating and/or information on a privacy ration, of the selected connectivity packages to the crowd-sourced service for providing information about locally available connectivity packages.

Another example (e.g., example 28) relates to a previous example (e.g., one of the examples 26 or 27) or to any other example, further comprising that the processor circuitry is to execute the machine-readable instructions to obtain, in case the client device is connected to a further gateway device, information on second available connectivity packages that are locally available at the further gateway device, and select one or more connectivity packages of the second available connectivity packages according to a similarity of one or more connectivity packages to the one or more connectivity packages previously selected from the available connectivity packages that are locally available at the gateway device.

Another example (e.g., example 29) relates to a previous example (e.g., one of the examples 22 to 28) or to any other example, further comprising that the instruction related to the selection of the one or more connectivity packages defines a first connectivity package and a second connectivity package to be selected for evaluating a difference between the first and second connectivity packages.

Another example (e.g., example 30) relates to a previous example (e.g., one of the examples 22 to 29) or to any other example, further comprising that the processor circuitry is to execute the machine-readable instructions to select the one or more connectivity packages for a one or more applications, with the instruction related to the selection of the one or more connectivity packages defining a connectivity package to be selected for data traffic of a specific application, and with data traffic of the one or more applications being routed via the one or more connections established by the gateway device.

Another example (e.g., example 31) relates to a previous example (e.g., example 30) or to any other example, further comprising that the processor circuitry is to execute the machine-readable instructions to select a first connectivity package for a first application and a second connectivity package for a second application, wherein the instruction related to the selection of the one or more connectivity packages defines the first connectivity package to be selected for data traffic of the first application and the second connectivity package to be selected for data traffic of the second application.

Another example (e.g., example 32) relates to a previous example (e.g., one of the examples 22 to 31) or to any other example, further comprising that the processor circuitry is to execute the machine-readable instructions to select the one or more connectivity packages based on one or more of a desired data throughput, a desired priority level, a desired latency, a desired transit network, a desired edge compute location, a desired edge compute capacity, a desired privacy level, a desired rating, a desired privacy rating, a desired trust rating, a desired performance rating, a desired level of use of artificial intelligence by services provided as part of or via the connectivity package, and a desired availability of a vertically integrated service.

Another example (e.g., example 33) relates to a previous example (e.g., one of the examples 22 to 32) or to any other example, further comprising that the processor circuitry is to execute the machine-readable instructions to provide a request related to a selected connectivity package to a server (564), the request indicating at least one characteristic of the selected connectivity package, such that an end-to-end connection between the server and the client device is to be established in line with the at least one characteristic of the selected connectivity package.

Another example (e.g., example 34) relates to a previous example (e.g., one of the examples 22 to 33) or to any other example, further comprising that the processor circuitry is to execute the machine-readable instructions to provide information on the selection and/or a use of the one or more connectivity packages to a charging server, the information on the selection and/or use of the one or more connectivity packages comprising an identification key that is specific to the client device.

An example (e.g., example 35) relates to an apparatus (20) for a client device (200), the apparatus comprising processor circuitry configured to obtain information on available connectivity packages, select one or more connectivity packages of the available connectivity packages for data traffic of the client device, provide an instruction related to the selection of the one or more connectivity packages to a gateway device, and communicate via one or more connections established by the gateway device, with the one or more connections being established between the gateway device and an endpoint of an internet service provider, the one or more connections being associated with the selected one or more connectivity packages.

An example (e.g., example 36) relates to a device (20) for a client device (200), the device comprising means for processing for obtaining information on available connectivity packages, selecting one or more connectivity packages of the available connectivity packages for data traffic of the client device, providing an instruction related to the selection of the one or more connectivity packages to a gateway device, and communicating via one or more connections established by the gateway device, with the one or more connections being established between the gateway device and an endpoint of an internet service provider, the one or more connections being associated with the selected one or more connectivity packages.

An example (e.g., example 37) relates to a method for a client device (200), the method comprising obtaining (210) information on available connectivity packages, selecting (220) one or more connectivity packages of the available connectivity packages for data traffic of the client device, providing (230) an instruction related to the selection of the one or more connectivity packages to a gateway device, and communicating (240) via one or more connections established by the gateway device, with the one or more connections being established between the gateway device and an endpoint of an internet service provider, the one or more connections being associated with the selected one or more connectivity packages.

Another example (e.g., example 38) relates to a client device (200, 512) comprising the apparatus or device according to one of the examples 22 to 36 (or according to any other example).

Another example (e.g., example 39) relates to a client device (200, 512) to perform the method of example 37 (or according to any other example).

Another example (e.g., example 40) relates to a previous example (e.g., one of the examples 38 or 39) or to any other example, further comprising that the client device is one of a mobile device, a smartphone, a wearable device, a tablet computer, a computer, a laptop computer, a desktop computer and a virtual reality, mixed reality or augmented reality device.

An example (e.g., example 41) relates to an apparatus (30) for a server (300, 564), the apparatus comprising interface circuitry (32), machine-readable instructions, and processor circuitry (34) to execute the machine-readable instructions to obtain a request related to a selected connectivity package from a client device, the selected connectivity package being selected by the client device, with the selected connectivity package being used to establish a connection between a gateway device used by the client device and a first endpoint of an internet service provider, the request indicating at least one characteristic of the selected connectivity package, and provide a service for the client device according to the at least one characteristic of the selected connectivity package.

Another example (e.g., example 42) relates to a previous example (e.g., example 41) or to any other example, further comprising that the processor circuitry is to execute the machine-readable instructions to establish a further connection between the server and a second endpoint of the internet service provider according to the at least on characteristic of the selected connectivity package.

Another example (e.g., example 43) relates to a previous example (e.g., one of the examples 41 or 42) or to any other example, further comprising that the at least one characteristic comprises one or more of the group of a data throughput, a priority level, a latency, a transit network, an edge compute location, an edge compute capacity, a privacy level, and a level of use of artificial intelligence by the service, and a use of a vertically integrated service.

An example (e.g., example 44) relates to an apparatus (30) for a server (300, 564), the apparatus comprising processor circuitry (34) configured to obtain a request related to a selected connectivity package from a client device, the selected connectivity package being selected by the client device, with the selected connectivity package being used to establish a connection between a gateway device used by the client device and a first endpoint of an internet service provider, the request indicating at least one characteristic of the selected connectivity package, and provide a service for the client device according to the at least one characteristic of the selected connectivity package.

An example (e.g., example 45) relates to a device (30) for a server (300, 564), the device comprising means for processing (34) for obtaining a request related to a selected connectivity package from a client device, the selected connectivity package being selected by the client device, with the selected connectivity package being used to establish a connection between a gateway device used by the client device and a first endpoint of an internet service provider, the request indicating at least one characteristic of the selected connectivity package, and providing a service for the client device according to the at least one characteristic of the selected connectivity package.

An example (e.g., example 46) relates to a method for a server (300, 564), the method comprising obtaining (310) a request related to a selected connectivity package from a client device, the selected connectivity package being selected by the client device, with the selected connectivity package being used to establish a connection between a gateway device used by the client device and a first endpoint of an internet service provider, the request indicating at least one characteristic of the selected connectivity package, and providing (320) a service for the client device according to the at least one characteristic of the selected connectivity package.

Another example (e.g., example 47) relates to a server (300, 564) comprising the apparatus (30) or device (30) according to one of the examples 41 to 45 (or according to any other example).

Another example (e.g., example 48) relates to a server (300, 564) to perform the method of example 46 (or according to any other example).

Another example (e.g., example 49) relates to a system comprising the gateway device (100, 514) according to one of the examples 20 or 21 (or according to any other example) and one or more client devices (200, 512) according to one of the examples 38 to 40 (or according to any other example).

Another example (e.g., example 50) relates to a system comprising a client device (200, 512) according to one of the examples 38 to 40 (or according to any other example) and a server (300, 564) according to example 47 (or according to any other example).

Another example (e.g., example 51) relates to a non-transitory, computer-readable medium comprising a program code that, when the program code is executed on a processor, a computer, or a programmable hardware component, causes the processor, computer, or programmable hardware component to perform one of the method of example 19, the method of example 37, and the method of example 46.

Another example (e.g., example 52) relates to a non-transitory machine-readable storage medium including program code, when executed, to cause a machine to perform one of the method of example 19, the method of example 37, and the method of example 46.

Another example (e.g., example 53) relates to a computer program having a program code for performing one of the method of example 19, the method of example 37, and the method of example 46 when the computer program is executed on a computer, a processor, or a programmable hardware component.

Another example (e.g., example 54) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a gateway device, the apparatus comprising interface circuitry, machine-readable instructions, and processor circuitry to execute the machine-readable instructions to:
obtain information on a plurality of available connectivity packages, with each connectivity package defining a connection between the gateway device and an endpoint of an internet service provider, and with each connectivity package being characterized by one or more connection performance parameters;
select one or more connectivity packages of the available connectivity packages for data traffic of a client device; and
route the data traffic of the client device via one or more connections between the gateway device and a corresponding endpoint of the internet service provider associated with a respective connectivity package of the selected one or more connectivity packages.

2. The apparatus according to claim 1, wherein the available connectivity packages provide different user experiences, as defined by the respective one or more connection performance parameters.

3. The apparatus according to claim 1, wherein the available connectivity packages are provided by two or more internet service providers.

4. The apparatus according to claim 1, wherein the information on the available connectivity packages is obtained, according to a geographic location, from a service for providing information on available connectivity packages of a plurality of internet service providers at a given location.

5. The apparatus according to claim 1, wherein the plurality of different connectivity packages differ with respect to one or more performance characteristics of the group of data throughput, priority level, latency, transit network, edge compute location, edge compute capacity, privacy level, rating, privacy rating, trust rating, performance rating, level of use of artificial intelligence by services provided as part of or via the connectivity package, and availability of a vertically integrated service.

6. The apparatus according to claim 1, wherein the processor circuitry is to execute the machine-readable instructions to establish one of a separate tunnel, a separate Internet Protocol (IP) destination, a separate Virtual Local Area Network (VLAN) or a separate Packet Data Unit (PDU) session to an endpoint of an internet service provider for each connectivity package being selected at the gateway device.

7. The apparatus according to claim 6, wherein the tunnel is a Point-to-Point Protocol over Ethernet, PPPoE, tunnel.

8. The apparatus according to claim 1, wherein the processor circuitry is to execute the machine-readable instructions to obtain, from the client device, an instruction related to the selection of the one or more connectivity packages and select the one or more connectivity packages according to the instruction related to the selection of the one or more connectivity packages.

9. The apparatus according to claim 8, wherein the instruction related to the selection of the one or more connectivity packages defines a connectivity package to be selected for data traffic of a specific application, wherein the processor circuitry is to execute the machine-readable instructions to route the data traffic of the specific application via the connection between the gateway device and the endpoint of the internet service provider associated with the selected connectivity package.

10. The apparatus according to claim 9, wherein the instruction related to the selection of the one or more connectivity packages defines a first connectivity package to be selected for data traffic of a first application and a second connectivity package to be selected for data traffic of a second application, wherein the processor circuitry is to execute the machine-readable instructions to route data traffic of the first application via a first connection between the gateway device and an endpoint of a service provider associated with a first connectivity package, and to route data traffic of the second application via a separate second connection between the gateway device and an endpoint of a service provider associated with a second connectivity package.

11. The apparatus according to claim 8, wherein the processor circuitry is to execute the machine-readable instructions to provide the information on the available connectivity packages to the client device, and wherein the instruction related to the selection of the one or more connectivity packages is based on the provided information on the plurality of available connectivity packages.

12. The apparatus according to claim 1, wherein the processor circuitry is to execute the machine-readable instructions to establish a first connection between the gateway device and an endpoint of a service provider associated with a first connectivity package and a separate second connection between the gateway device and an endpoint of a service provider associated with a second connectivity package, with the first and second connection being established via the same modem of the gateway device.

13. An apparatus for a client device, the apparatus comprising interface circuitry, machine-readable instructions, and processor circuitry to execute the machine-readable instructions to:
obtain information on available connectivity packages;
select one or more connectivity packages of the available connectivity packages for data traffic of the client device;
provide an instruction related to the selection of the one or more connectivity packages to a gateway device; and
communicate via one or more connections established by the gateway device, with the one or more connections being established between the gateway device and an endpoint of an internet service provider, the one or more connections being associated with the selected one or more connectivity packages.

14. The apparatus according to claim 13, wherein the processor circuitry is to execute the machine-readable instructions to obtain at least a portion of the information on the available connectivity packages from the gateway device.

15. The apparatus according to claim 14, wherein the processor circuitry is to execute the machine-readable instructions to obtain, in case the client device is connected to a further gateway device, information on second available connectivity packages that are locally available at the further gateway device, and select one or more connectivity packages of the second available connectivity packages according to a similarity of one or more connectivity packages to the one or more connectivity packages previously selected from the available connectivity packages that are locally available at the gateway device.

16. The apparatus according to claim 13, wherein the processor circuitry is to execute the machine-readable instructions to select the one or more connectivity packages for a one or more applications, with the instruction related to the selection of the one or more connectivity packages defining a connectivity package to be selected for data traffic of a specific application, and with data traffic of the one or more applications being routed via the one or more connections established by the gateway device.

17. The apparatus according to claim 16, wherein the processor circuitry is to execute the machine-readable instructions to select a first connectivity package for a first application and a second connectivity package for a second application, wherein the instruction related to the selection of the one or more connectivity packages defines the first connectivity package to be selected for data traffic of the first application and the second connectivity package to be selected for data traffic of the second application.

18. The apparatus according to claim 13, wherein the processor circuitry is to execute the machine-readable instructions to provide a request related to a selected connectivity package to a server, the request indicating at least one characteristic of the selected connectivity package, such that an end-to-end connection between the server and the client device is to be established in line with the at least one characteristic of the selected connectivity package.

19. An apparatus for a server, the apparatus comprising interface circuitry, machine-readable instructions, and processor circuitry to execute the machine-readable instructions to:
obtain a request related to a selected connectivity package from a client device, the selected connectivity package being selected by the client device, with the selected connectivity package being used to establish a connection between a gateway device used by the client device and a first endpoint of an internet service provider, the request indicating at least one characteristic of the selected connectivity package; and
provide a service for the client device according to the at least one characteristic of the selected connectivity package.

20. The apparatus according to claim 19, wherein the processor circuitry is to execute the machine-readable instructions to establish a further connection between the server and a second endpoint of the internet service provider according to the at least on characteristic of the selected connectivity package.
